(19) United States
(12) Patent Application Publication
(10) Pub. No.: US 2013/0263417 A1
(43) Pub. Date: Oct. 10, 2013

(54) TOOL

(71) Applicants: Martin Schmidt, Schmalkalden (DE); Peter Lutze, Soltau (DE)

(72) Inventors: Martin Schmidt, Schmalkalden (DE); Peter Lutze, Soltau (DE)

(73) Assignee: RENNSTEIG WERKZEUGE GMBH, Viernau (DE)

(21) Appl. No.: 13/994,317

(22) PCT Filed: Dec. 22, 2011
(86) PCT No.: PCT/EP11/73742

§ 371 Date: Jun. 14, 2013

(30) Foreign Application Priority Data
Dec. 22, 2010 (DE) 10 2010 061 497.1

(51) Int. Cl. B23P 13/00

(52) U.S. Cl. CPC B23P 13/00
USPC 29/283.5

(57) ABSTRACT

The invention relates to tools (1), such as crimping tools, comprising an acting part (31), for moving a movable tool (7) relative to a stationary tool (6) for example, wherein furthermore the acting part (31) can be moved in a motorized manner. In order to specify such tools in an advantageous embodiment, a longitudinal axis (L) of an electric motor (9) provided in order to drive the acting part (31) extends below the acting part (31) when the motor is horizontally oriented.

The invention relates to a tool, for example, a crimping tool, comprising an activating part, for moving a movable tool leg relative to a stationary tool leg, or for rotationally acting on crimping indenters that are directed in a star-shaped manner toward a crimping region, the activating part being movable in a motorized manner.

Such tools, which may also be called servo tools, have already become known in many respects. Reference is made, for example, to U.S. Pat. No. 4,475,374 A1, U.S. Pat. No. 6,662,620 B1 and U.S. Pat. No. 5,758,729 A.

Proceeding from the mentioned prior art, it is an object of the invention to improve a motor-driven tool that has an activating part in such a manner that a configuration is provided that can be handled in a particularly advantageous manner.

A possible solution to the object is achieved according to a first inventive concept for a tool in the case of which a longitudinal axis of an electric motor provided for driving the activating part extends below the activating part when the motor is oriented horizontally.

Due to the fact that the motor extends in the mentioned orientation below the activating part, an advantageously beneficial action on the activating part can be achieved. Also, through this basic arrangement, a plurality of tool types can be formed which have this arrangement. Thus, for example, tools having two tool legs, but also tools comprising crimping indenters directed in a star-shaped manner toward a crimping region can be formed.

Further features of the invention are described and illustrated hereinafter, including in the description of the figures and in the drawing, often in their preferred association with the concept already explained above; however, they can also be important in association with only one or a plurality of individual features that are described herein or illustrated in drawings, or can be important independently or in another overall context.

Thus, it is preferred that a handle region of the tool extends above the electric motor and independently thereof. Alternatively, it can also be provided that the electric motor is enclosed by the handle region. With regard to tools having two tool legs, it is preferred that for a closing movement, the movable tool leg can be moved relative to the stationary tool leg in a motorized manner and, furthermore, the movable tool leg is pivoted at a pivot joint formed on the stationary tool leg so as to be pivotable relative to the stationary tool leg.

It is further particularly preferred here that the motor acts on the movable tool leg on the jaw side of the pivot joint.

The motor acts directly where the application of force is required. In the case of such a configuration, the movable tool leg is not required to transmit—via the pivot joint—a significant torque. Also, it is not required that the tool leg facing away from the jaw extends beyond the pivot joint. Overall, in terms of the drive, an advantageous compact configuration of the tool can be achieved in this manner.

With regard to the tool concept, as mentioned, this can specifically concern crimping tools with crimping indenters that are disposed in a star-shaped manner directed toward a crimping region. In this embodiment, these crimping indenters are subjected radially on the outside to rotational action by means of the mentioned activating part so as to carry out the crimping movement.

Furthermore, a grip-through opening can be formed between the handle region and the electric motor. A housing of the electric motor can form a boundary of the grip-through opening. The grip-through opening can enable very safe handling of the tool to be achieved.

Alternatively and preferably, the handle region and preferably also the motor region, if not already coinciding, are formed to project freely at one end. This results in a U-shaped arrangement, the U-legs accommodating the electric motor on the one hand and at least a portion of the tool legs and optionally a rechargeable battery on the other hand. In the U-web region, the activating part is disposed and the jaw is formed. The jaw opens in the opposite direction to the U-opening. In the case of four-indent crimping, the four-indent receptacle is also disposed in the U-web. However, it opens perpendicular to a plane in which the U-legs and the U-web extend.

Furthermore, the handle region, here in particular in the case of indent crimping, can be formed to coincide with the region of the electric motor. Then, there is, as it were, only one leg of the U. The U-arrangement thus changes substantially into an L-arrangement.

Furthermore, with regard to the configuration of the tool as a crimping tool, but also with regard to tools having two tool legs, one of which is movable relative to the other, it is preferred that the activating part is movable via a gear drive. Thus, a precise movement of the activating part by means of the electric motor is possible while, at the same time, high forces can be applied.

It is also preferred that for driving the activating part, the electric motor acts on a worm wheel. The worm wheel can be formed in one piece with the activating part or can be rigidly connected thereto. For this, the activating part can comprise a first gearing on the outside, in particular radially on the outside if it is circular-arc-shaped, and the worm drive can form a second gearing that is in engagement therewith.

It is also preferred that a longitudinal axis of the worm acting on the worm wheel is disposed to coincide with a longitudinal axis of the electric motor. Thus, the two parts are oriented in alignment with one another. This results in a compact elongated arrangement one behind the other.

Furthermore, the handle region can be formed on a frame part, on the lower frame portion of which the electric motor is secured in a suspended manner. Constructionally, such a frame part is at the same time the “bracket”, both for securing the electric motor and also for forming the handle region.

More preferably, the frame can be formed as a double frame. This is preferred with regard to two frame parts situated next to one another and more preferably also with regard to frame parts that also correspond at least approximately to one another in terms of their geometry. High stability and, at the same time, efficient producibility is achieved.

The configuration as a double frame can also be configured such that it is reduced to the region that accommodates or holds the activating part.

Furthermore, it can be provided that an adjustment guide for the activating part is formed in the frame part. By this, in particular in the case of a configuration of the tool as a crimping tool, adaptation with regard to different crimping processes can be achieved, for example.

Furthermore, the adjustment range is preferably provided to be variable.

It is also preferred that the activating part is disposed to be rotatable. It can be provided to be rotatable about a rotational axis disposed in the mentioned horizontal plane and/or offset parallel thereto. In the case of a configuration of the tool as a crimping tool having crimping indenters extending in a star-shaped manner toward one another, the activating part can have a rotational axis that extends about the center point of the crimping indenters and/or about the extended longitudinal axes thereof.

In particular, although not limited thereto, it is also preferred with regard to the configuration of the tool having two tool legs that the action on the movable tool leg is carried out by means of a toggle lever drive. This results in addition in a configuration that is advantageous in terms of forces. Pivoting a first lever of the toggle lever drive to the movable tool leg is preferably carried out here in direct alignment with the free jaw region of the tool. It is further preferred that the other lever, the second lever of the toggle lever drive, is formed integrated into a worm wheel on which the motor acts, preferably a worm connected to the motor shaft, more preferably a worm gear connected in extension of the motor shaft. The second lever only moves as part of the worm wheel. Independent movement of the second lever relative to the worm wheel is preferably not possible in this configuration.

More preferably, the arrangement is provided in such a manner that if two tool legs are provided, the tool legs extend in a common handle portion. The possibly stationary and also the possibly movable tool leg are covered by a handle portion, more preferably accommodated therein. More preferably, the movable tool leg and the stationary tool leg are surrounded by the handle portion over a significant portion of their length. This can in particular be achieved in a useful manner if the extent of the movable tool leg from the pivot joint to the jaw region is comparatively long so that the pivot movement of the movable tool leg when opening and closing is comparatively small, so that gripping over or gripping around with the hand therefore is spatially possible without problems even taking account of the moving movable tool leg.

Comparatively long means here in particular that the tool leg, from the free end at the jaw up to the pivot joint in which the tool leg is pivotably mounted, has a dimension that corresponds ten- to a hundred-times or more to the dimension of the travel movement from the open into the closed position.

Moreover, the arrangement is preferably selected such that in a side view of the tool, i.e., usually in the direction of an axis of rotation of the pivot joint, the toggle lever drive is disposed between the motor shaft that operates here as a worm shaft, optionally between the extension of the motor shaft by means of the mentioned worm, and the movable cheek piece of the movable tool leg. The toggle lever drive as a whole is therefore disposed far to the front in the region of the jaw portion with regard to a vertical alignment while providing conventional handling of the tool.

It is also preferred that the pivot joint is located in the handle region. Also, the user can grip with his hand around the region in which there is disposed the pivot joint that connects the movable tool leg to the stationary tool leg. It is also possible here that the pivot joint is disposed at that end region of the handle region that faces away from the jaw. A relatively long configuration of the tool legs requires only a comparatively small angular movement of the tool legs relative to one another when opening and closing.

Preferably, the movable tool leg, on the side facing away from the jaw, does not extend beyond the pivot joint or only extends beyond it to an insignificant extent. More preferably, it extends only so far that a secure pivot joint connection can be achieved. Most preferably, it also extends in such a manner that beyond the pivot joint axis, there is no overhang of the free end region of the articulated tool leg beyond the stationary tool leg or a related frame portion when the movable tool leg is pivoted.

It is further preferred that at least the movable tool leg, in particular the jaw of the movable tool leg, is composed of plate parts, and that the force transmission of the motor to the movable tool leg takes place on a web connecting the plate parts. Preferably, the movable tool leg is composed of two plate parts that each extend completely or at least substantially over the entire length of the movable tool leg.

Furthermore, it is also preferred that between the motor and the tool legs which, as discussed, are formed such that a hand can grip preferably over both of them, a grip space is formed in the vertical direction with regard to a horizontal orientation of the longitudinal axis of the electric motor, through which grip space the hand can grip during the use.

For this it in particular also preferred that the stationary tool leg is connected to a preferably closed frame part or is a part of this frame part. The pivot joint is preferably formed on a first leg of the frame part and, accordingly, the movable and also the stationary tool legs are disposed thereon. On a second leg of the frame, which second leg extends substantially in the same direction as the mentioned first leg, preferably, the motor is mounted. These mentioned first and second legs are preferably also long legs as opposed to short legs which, in the transverse direction to the long legs, connect the long legs to one another. More preferably, the frame part is composed in the region of the stationary tool leg, and particularly preferably also in total, of two preferably identical plate parts. In a side view, the plate parts of the frame and/or of the stationary tool leg are disposed one above the other. They can leave clearance between them. In particular, in the region of the stationary tool leg, the movable tool leg can be accommodated between these plate parts. The connection of the plate parts can be implemented via connecting bolts.

The above- and below-specified ranges or value ranges also include with regard to the disclosure all intermediate values, in particular in 1/10 steps of the respective dimension, where applicable also dimensionless, thus, for example, 1/10 mm or 10 cm etc., on the one hand for limiting the mentioned range boundaries from below and/or above, but also, alternatively or additionally, with regard to the disclosure of one or a plurality of singular values from a respective range.

The invention is explained below with reference to the accompanying drawing which, however, merely shows an exemplary embodiment. In the figures:

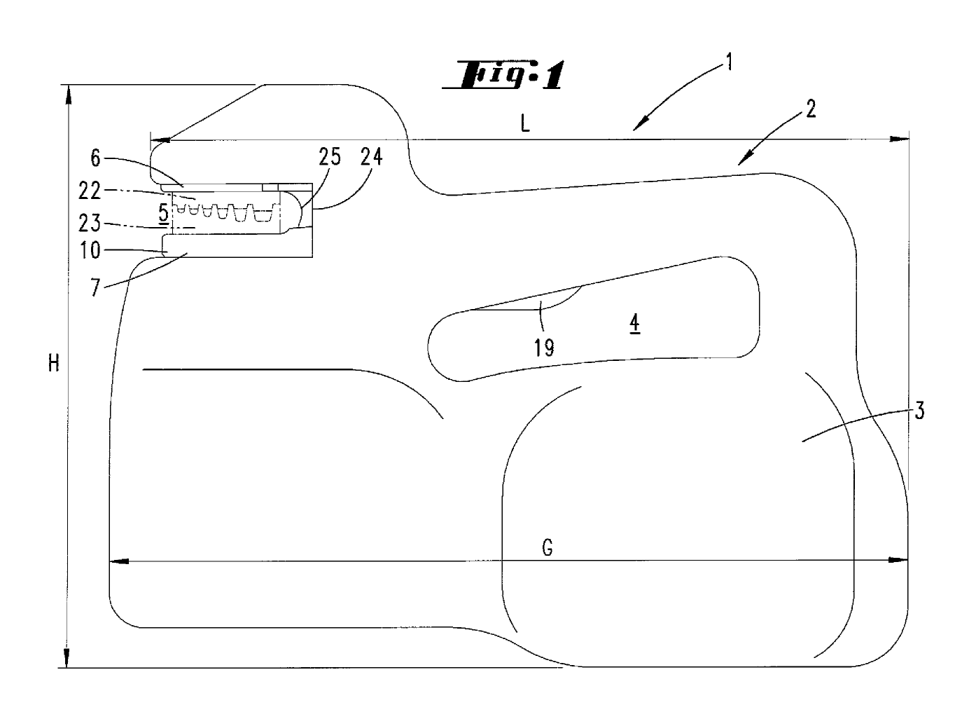

FIG. 1 shows a side view of the tool;

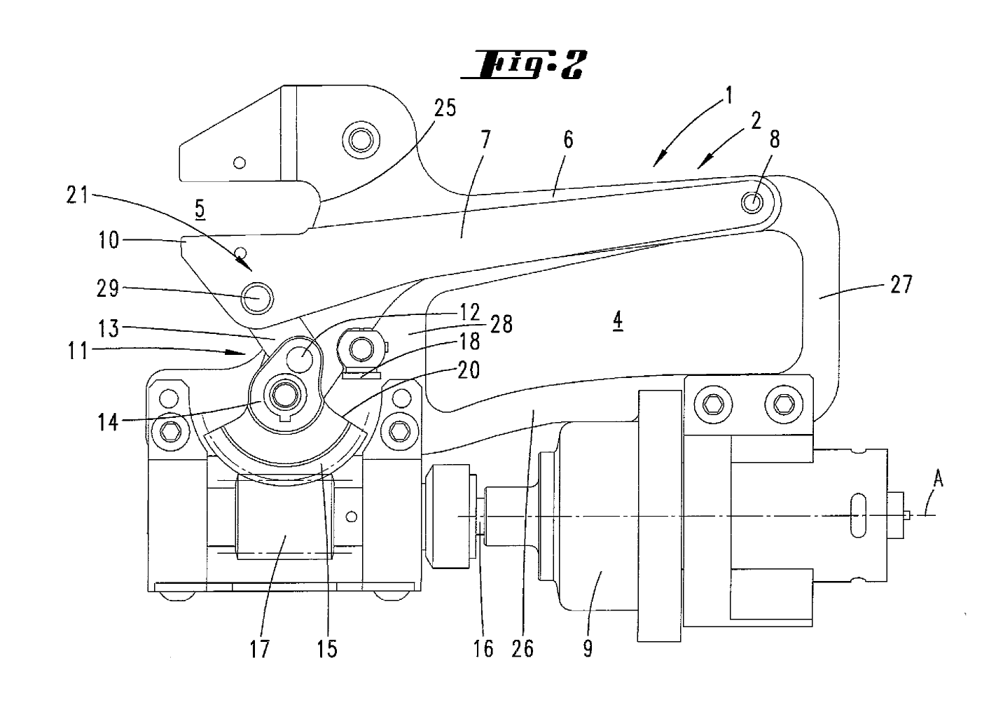

FIG. 2 shows an illustration according to FIG. 1, with the housing removed;

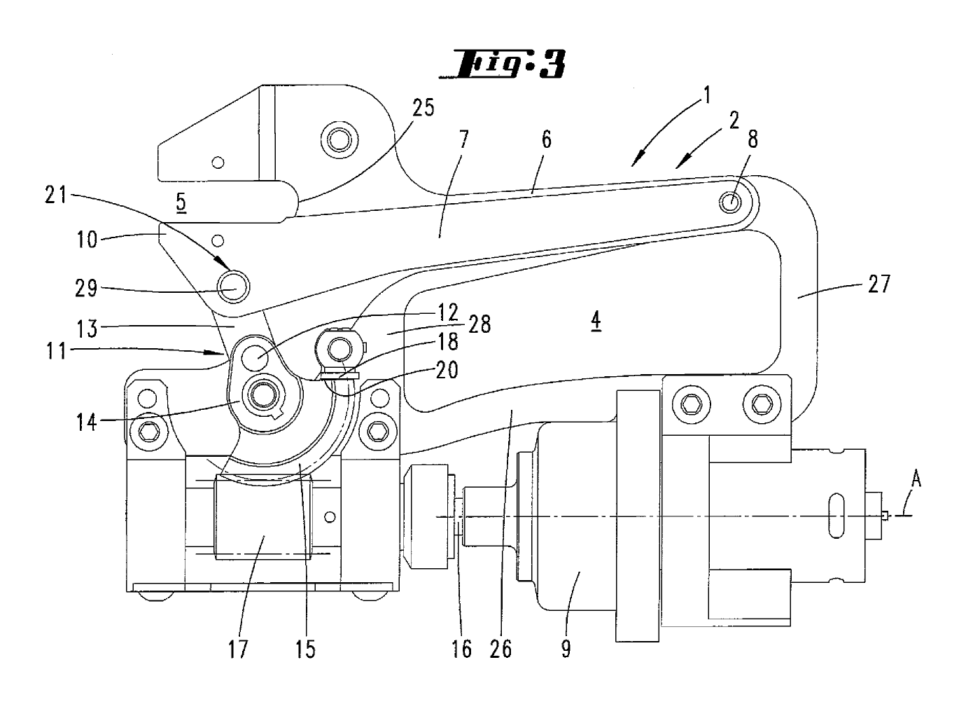

FIG. 3 shows an illustration according to FIG. 2, but with the jaw closed;

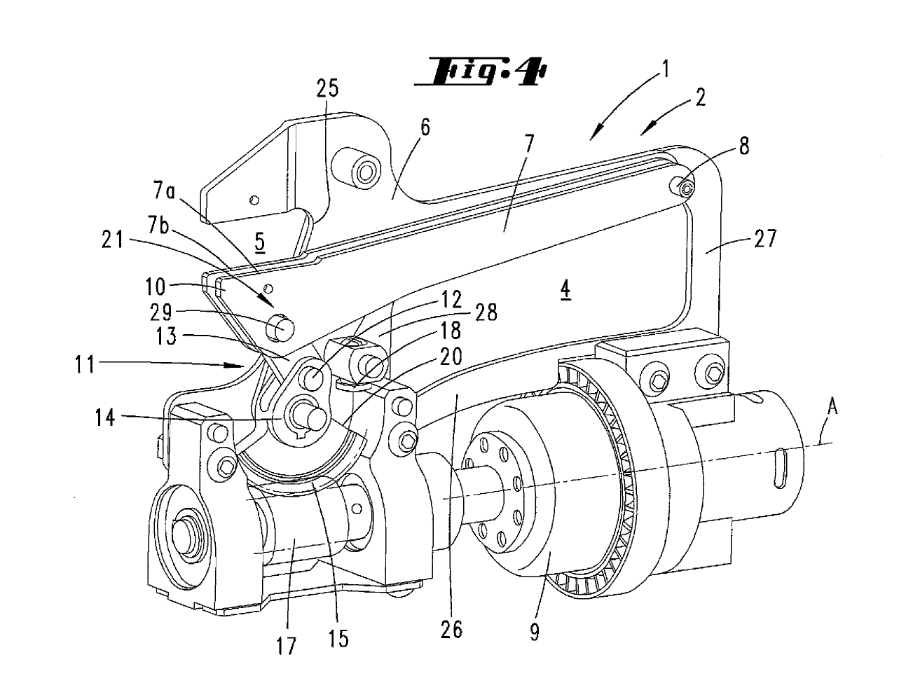

FIG. 4 shows a perspective view of the subject matter according to FIG. 2;

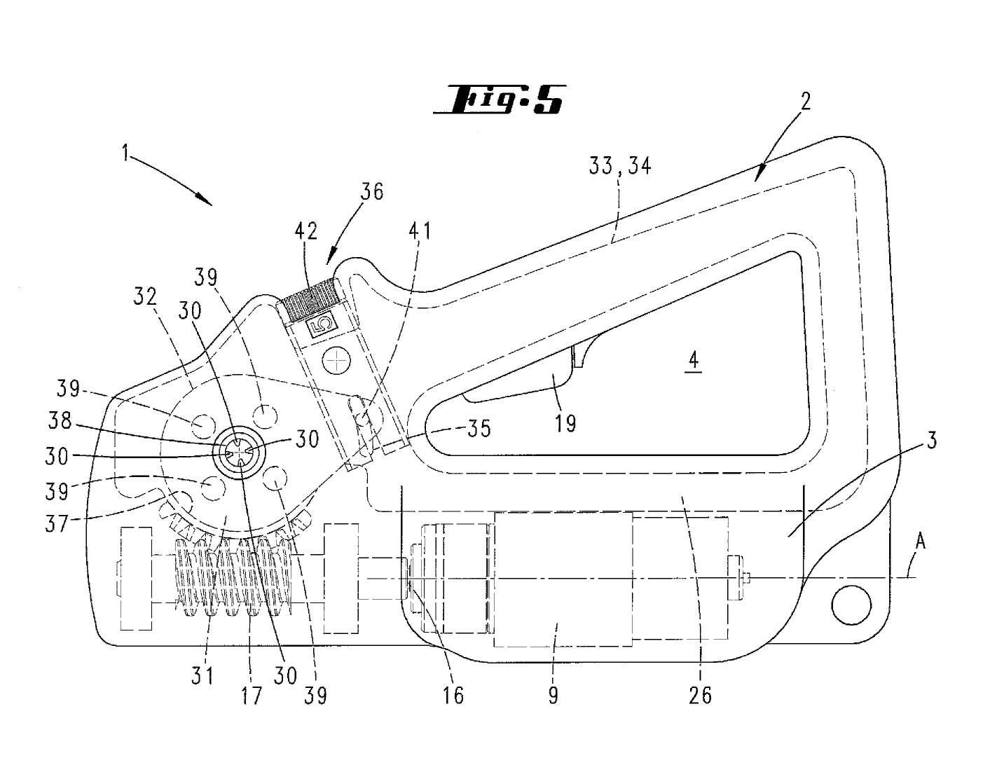

FIG. 5 shows a side view of the tool in an embodiment as a crimping tool having crimping indenters that are movable toward one another in a star-shaped manner;

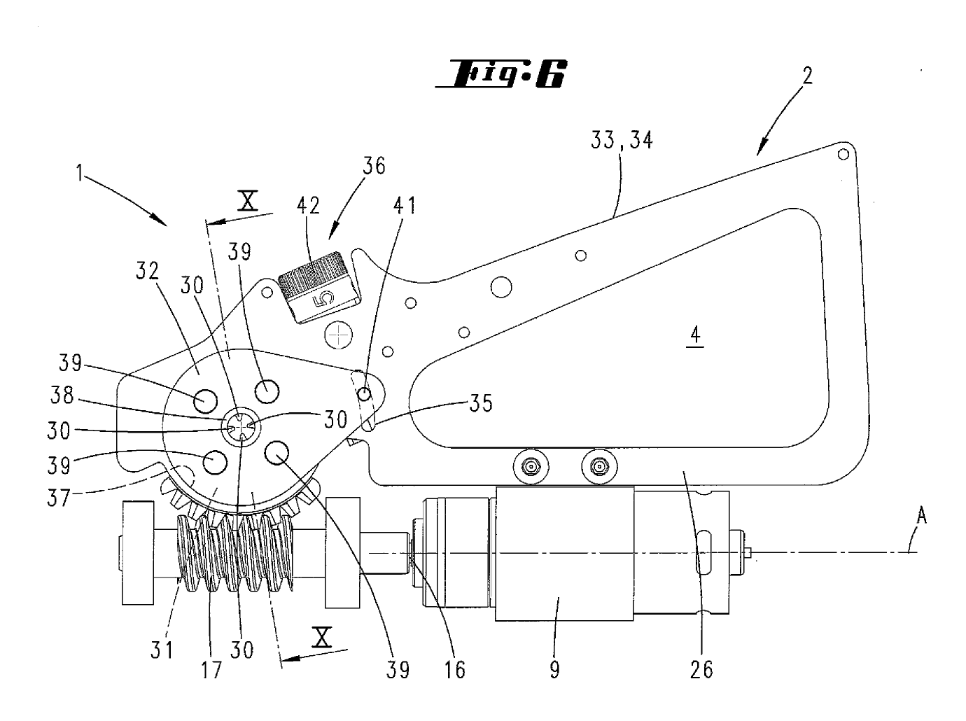

FIG. 6 shows an illustration according to FIG. 5, with housing parts removed;

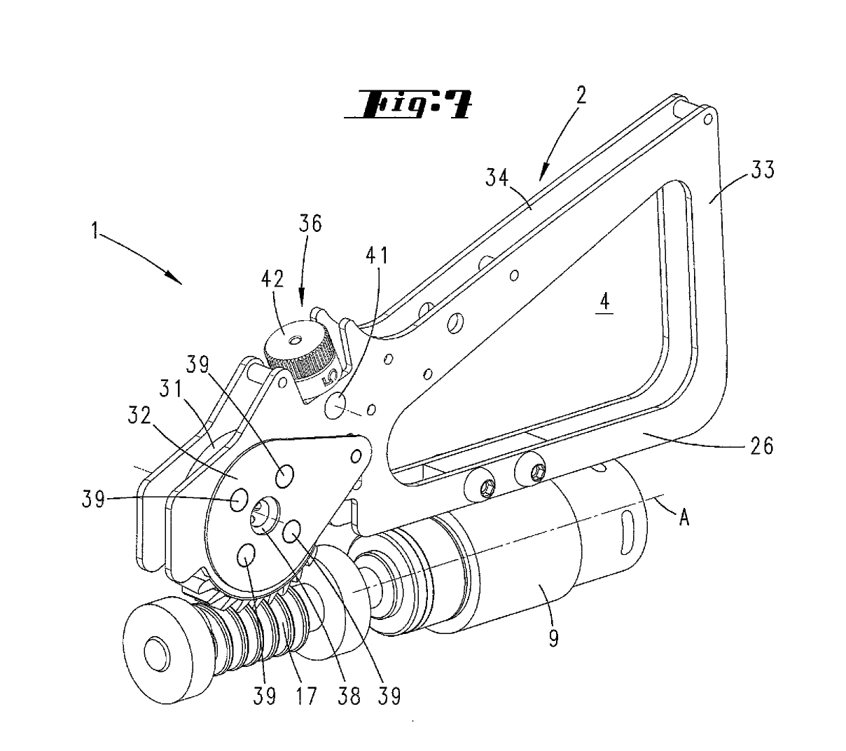

FIG. 7 shows a perspective illustration of the subject matter according to FIG. 6;

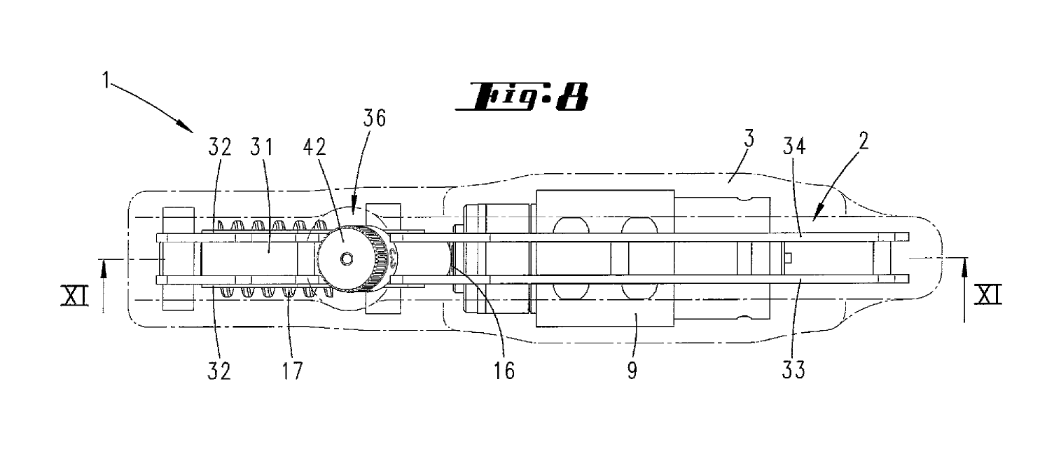

FIG. 8 shows a view from above onto the subject matter according to FIG. 6 and/or FIG. 7;

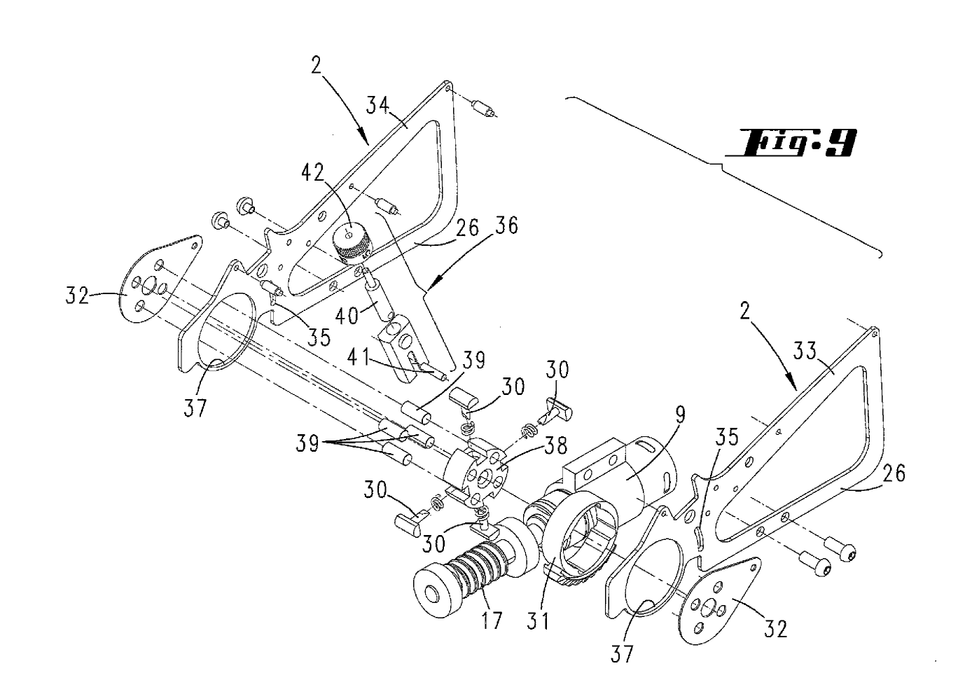

FIG. 9 shows an exploded view of the subject matter according to FIG. 6 and/or FIG. 7;

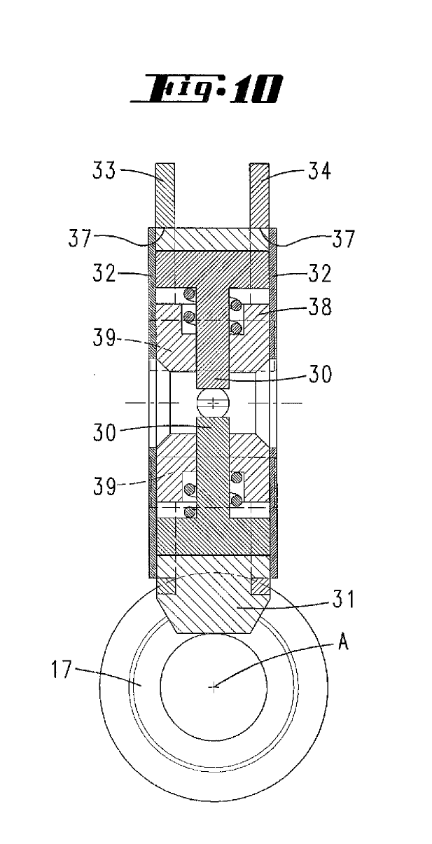

FIG. 10 shows a cross-section through the subject matter according to FIG. 6, cut along the line X-X;

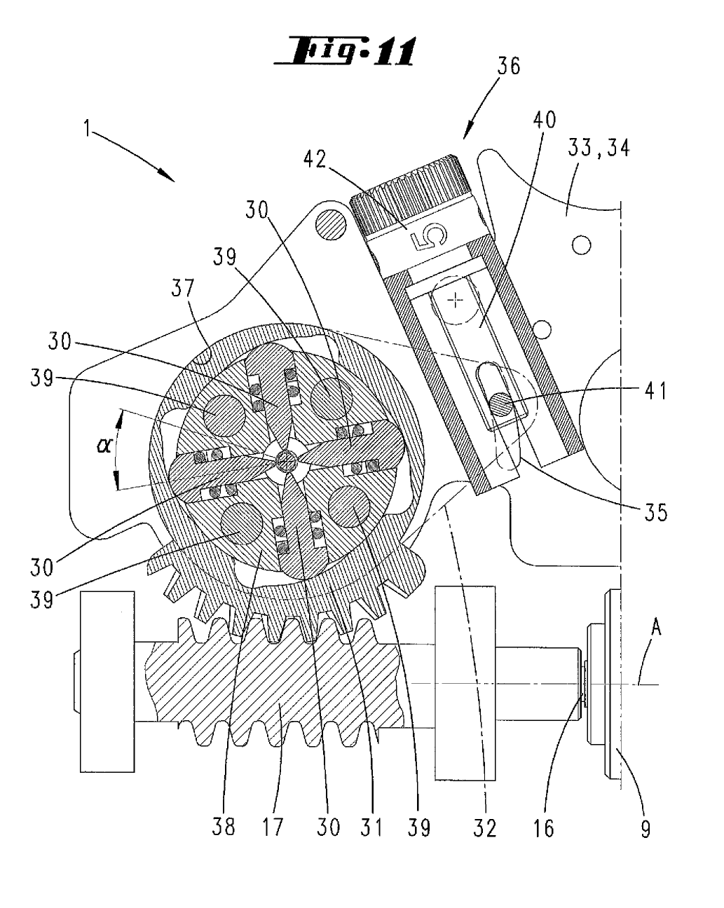

FIG. 11 shows a cross-section through the subject matter according to FIG. 8, cut along the line XI-XI;

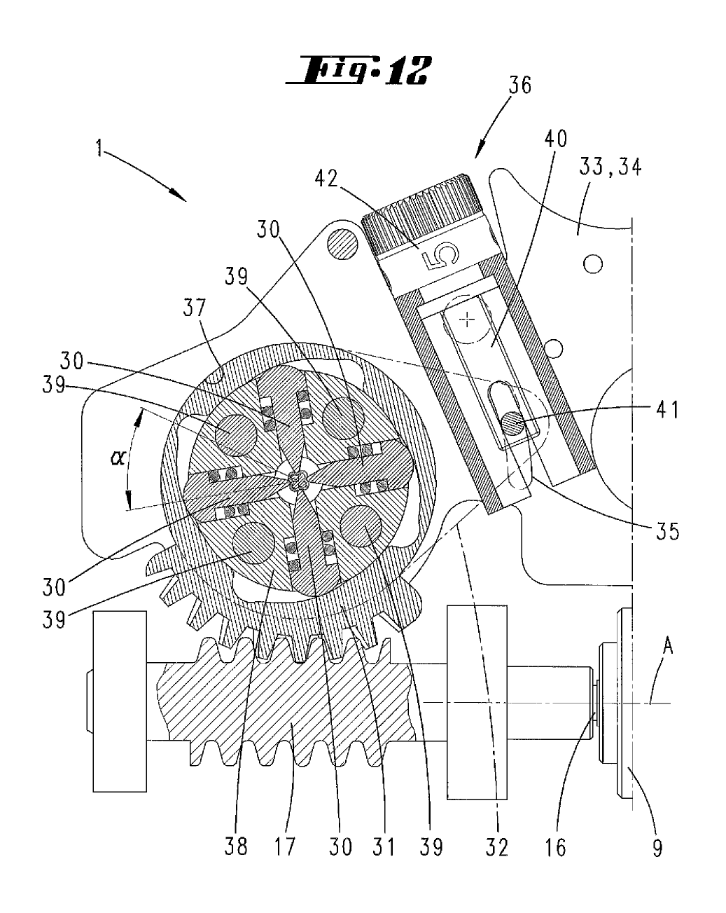

FIG. 12 shows an illustration according to FIG. 11, at the end of a crimping operation;

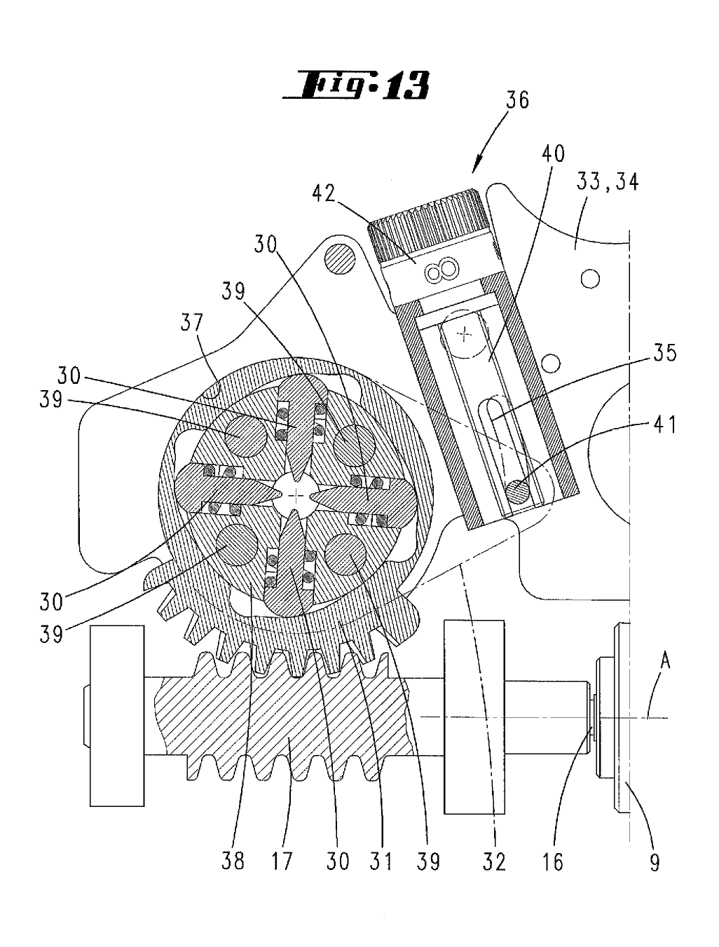

FIG. 13 shows an illustration according to FIG. 10 and/or FIG. 11 after completion of adjustment of the activating part;

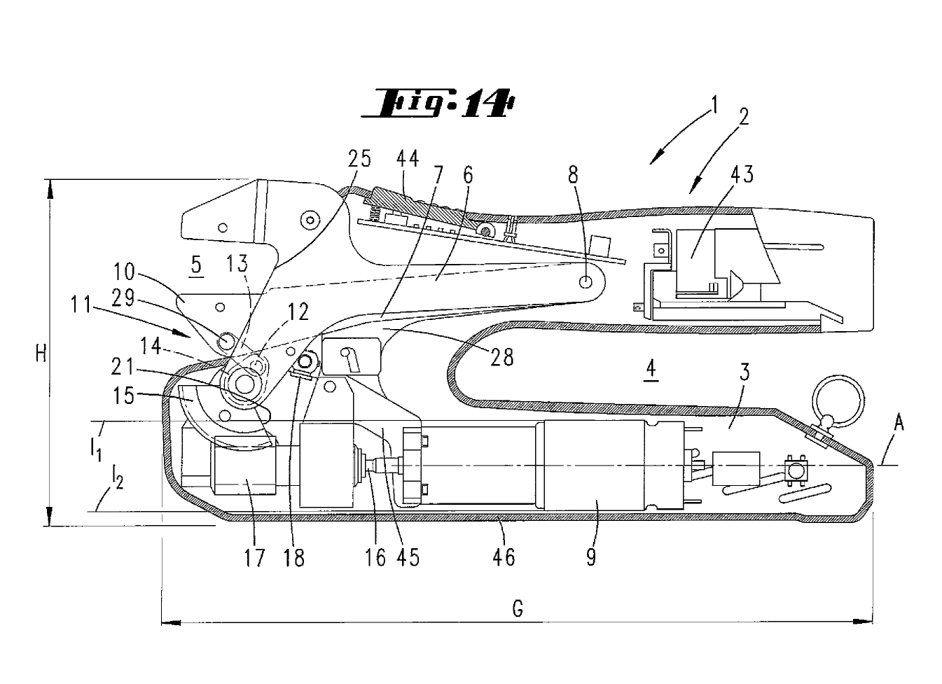

FIG. 14 shows—partially cut open—an illustration of another embodiment with a handle formation that is open at the rear; and

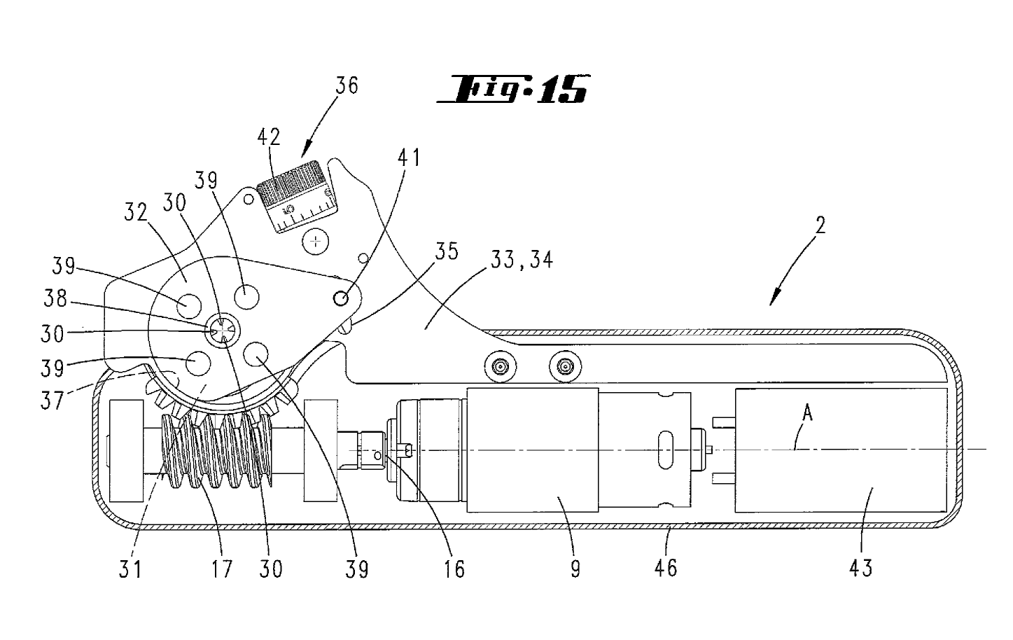

FIG. 15 shows a side view of a crimping tool in a rod- or L-shaped design.

Illustrated and described in first instance with regard to FIGS. 1 to 4 is a tool 1 formed as a crimping tool for pressing cable sleeves or cable connectors. This is a handheld device that preferably can be guided and operated with one hand. The tool 1 can be operated in a motorized manner.

The tool 1 has a handle region 2 which, for conventional handling, is formed above the motor 9 and the drive that are disposed in a lower housing region 3. In this view, a tiered-like subdivision is provided, the tool legs 6, 7 extending in an upper level and a jaw 5 being formed in said upper level, while in a lower level, in the direction of extent of the tool legs 6, 7 and disposed one behind the other, the electric motor 9 and a drive are arranged, the drive preferably being formed by a worm interacting with a worm wheel 15. A grip-through opening 4 and the toggle lever drive 11 are disposed, as it were, in an intermediate level.

In this embodiment, the toggle lever 11 is to be regarded as an activating part. In a narrower sense, the lever 14 and/or the worm wheel 15, which are formed here combined in one piece, are the activating part; the lever 13 can also be replaced by a curved guide on the movable tool leg 7.

The tool 1 can preferably be handled such that a hand of the user grips around the tool in the handle region 2, and the motor is located vertically therebelow. A vertical line through a center of gravity of the tool 1 in this configuration extends preferably through the handle region 2.

Furthermore, for independently operating the tool 1, it is also possible for a rechargeable battery to be provided, which is not illustrated in the drawing. The battery can be axially flanged to the motor, to the rear of the worm, or can be plug-connectable. The battery can also be disposed in the upper handle region 2.

In the vertical direction between the handle region 2 and the housing region 3, the grip-through opening 4 is formed. The jaw 5 is formed by free end regions of the stationary tool leg 6 and the movable tool leg 7. When in use, crimping inserts 22, 23 are held in the free end regions of the tool legs 6, 7. The jaw 5 ends on the pivot joint side at a significant distance from the pivot joint. With regard to the total length of the movable tool leg, the jaw ends at a distance of ⅓ to 9/10 of the length before the pivot joint (joint axis). The end of the jaw 5 is set by a housing portion 24 that crosses the jaw 5 at its end and/or by a vertical portion 25 of the stationary and/or movable tool leg(s) 6, 7.

As is further apparent from FIGS. 2 and 3, the movable tool leg 7 is secured to the stationary tool leg 6 by means of a pivot joint 8. The action of the motor 9 on the movable tool leg 7 is effected on the jaw side of the pivot joint 8. The pivot joint 8 is located in the handle region 2. The tool legs 6, 7 also extend over a substantial portion of their length within the handle region 2. The substantial portion of the length refers to ⅕ or more up to, for example, ¾ of the total length of the tool legs.

From the pivot joint 8 up to a tip 10 of the jaw, the movable tool leg 7 is formed as rigid continuous lever. In the lower region of the jaw of the movable tool leg 7, preferably vertically aligned with the jaw 5 with reference to, for example, the illustration in FIG. 2, the movable tool leg 7 is acted-on by the toggle lever drive 11. The toggle lever drive 11 has a toggle joint 12 and two levers 13, 14. The first lever 13 which connects the toggle joint 12 to the movable tool leg 7 is pivoted in a widened portion 21 at the jaw end of the movable tool leg 7. The widened portion 21 represents a widening of the plate parts of the tool leg 7 in a direction transverse to the pivot joint axis. The thickness of the plate parts is preferably the same over their entire extent. This also relates preferably to the plate parts which form the frame and/or the stationary tool leg.

The lever 14 is part of a gear wheel 15, the worm wheel, that is driven by the motor 9. For driving the gear wheel 15, a worm 17 is flanged to the motor shaft 16 in axial extension of the motor shaft 16, which worm meshes with the gear wheel or worm wheel 15. As can be seen here, the motor shaft 16 is specifically the worm shaft.

The worm wheel 15 is preferably formed only over a segment of a circle. More preferably, it is formed over a segment of a circle in an angular range of from 60° to 120°.

Furthermore, the tool is preferably based on a frame construction. In particular, the stationary parts of the jaw and preferably the motor are secured to frame parts, or form these frame parts themselves at least partially. This can involve a rectangular frame or a frame bordering a rectangular area. Furthermore, the frame is preferably formed from flat material. The frame parts can also be designated as frame plates.

In particular, the movable tool leg 7 preferably consists of two plate parts 7a and 7b; cf., e.g. FIG. 4. These are not plate parts of the frame. More preferably, the stationary tool leg 6 which can be part of the frame is likewise formed from two parts, this not being shown in detail. More preferably, it is formed from two identical parts which, in the lateral direction, i.e., for example perpendicular to the plane of the drawing in FIG. 2, are located one above the other. Between these parts of the stationary tool leg, the movable tool leg is disposed. More preferably, the frame as a whole is formed accordingly from two parts. The parts can be connected by pins extending in the direction of the pivot joint axis and/or, for example, by fastening screws such as the fastening screws which hold the motor on the frame, and further, with spacers placed therebetween, for example. Furthermore, the plate parts 7a and 7b are connected by a pin 29 on which the lever 13 of the toggle joint 12 is engaged.

On an approximately horizontally extending first leg of the frame, which leg is the upper one in a side view, the pivot joint 8 is formed. The pivot joint 8 can also be secured to a surrounding housing. The stationary tool leg 6 can also be additionally provided and can be secured to the first leg of the frame or a surrounding housing. On a lower second leg 26 of the frame, which second leg extends approximately in the same direction as the first leg, the motor 9 and preferably also the drive including the worm 17 is secured. Furthermore, two shorter third and fourth legs 27, 28 can be provided. The legs 27, 28 connect the first and second legs 6, 26 to one another. If provided, they leave the already described grip-through opening 4 between them. The fourth rear leg 28 also extends in vertical alignment with the motor 9. The front third leg 27, viewed in the direction toward the jaw 5, extends from the motor 9 but upstream of the jaw 5.

Driving by means of the motor 9 takes place in a reciprocating manner. In the course of the complete closing of the jaw 5, a flank 20, cf. FIGS. 2, 3, moves against the end stop 18. Reaching the end stop 18 is assessed as full implementation of the crimping, unless a load threshold value has previously already been reached. The direction of rotation of the motor 9 then acts in reverse and the tool opens again.

When carrying out the crimping operation, the motor load is suitably detected by monitoring the motor current. Power input to the motor above a predefined load threshold value results in switching-off of the motor so as to avoid overloads.

For actuating the tool or for triggering the crimping operation, a switch 19 is provided in the handle region 2. By actuating the switch 19, a crimping operation is triggered, for example. According to a first embodiment in this respect, the user has to keep the switch 19 constantly pressed for carrying out the crimping operation. Releasing the switch 19 results in standstill. In a second embodiment, it is provided that upon reaching a defined closed position, full closing takes place automatically. The defined closed position, with regard to a maximum closing travel, can be set at 60 to 95% of the closing travel. 100% closing travel corresponds to the fully closed position.

The size of the tool including the housing, according to FIG. 1, in the direction of extent of the tool legs 6, 7 is substantially defined by a length L of the movable tool leg (measured from the free end up to the axis of the pivot joint 8). A total length G measured in this direction of extent preferably corresponds to 1.1- to 1.9-times the length L. A height H measured transverse thereto preferably corresponds to the length L or is smaller, and, for example, is only 0.6-times to 0.9-times the length L.

A second embodiment of the tool is illustrated with reference to FIGS. 5 to 13.

This involves a tool 1, see for example FIG. 11, which has a plurality of crimping indenters 30, in the exemplary embodiment four crimping indenters 30, which are disposed in a star-shaped manner directed toward one another. The crimping indenters 30 of the tool 1 of this embodiment are driven by means of the activating part 31 so as to perform a crimping movement. The activating part 31 is secured on a movable frame guide part 32. In detail, the frame guide part consists of two flat parts that are each disposed on a fiat side of the activating part. The electric motor 9 also provided in this embodiment, here too, has a longitudinal axis A that extends below the activating part 31. In this embodiment too, the handle region 2 is formed to extend above the electric motor 9 and independent thereof.

In this embodiment too, a grip-through opening 4 remains between the electric motor 9 and the handle region 2.

In this embodiment too, the electric motor 9 is coupled to a worm wheel 17 that is disposed coaxial with a drive shaft of the electric motor 9 and is driven by the drive shaft. A longitudinal axis of the worm wheel 17 coincides with the longitudinal axis A of the electric motor 9.

As also shown in the first embodiment, frame parts 33 and 34, where applicable frame parts forming a closed frame, are also provided in this embodiment, one frame part 33 or 34 in principle being sufficient. The frame parts 33, 34 are disposed side by side in the same manner as described with regard to the first embodiment.

On the upper side of the frame parts 33, 34, the handle region 2 is formed or is used as such, and the motor 9 is secured in a suspended manner on the lower leg 26 of a frame part 33, 34.

The frame guide part 32 is pivotably accommodated in one or preferably both frame parts 33, 34. Via an adjustment guide 35, the frame guide part 32 is pivotable relative to the frame parts 33, 34. The adjustment guide 35 is adjustable by a setting part 36, preferably manually.

With reference to FIG. 9, it is important as a further detail that a circular opening 37 is formed at the jaw end in each of the frame parts 33, 34. In this circular opening, the activating part 31 is accommodated in a rotatable manner.

Furthermore, within the activating part 31, an indenter guide part 38 is accommodated in which the crimping indenters 30 are individually held. The indenter guide part 38 is secured to the frame guide parts 32 by means of fixing pins 39. Hereby, the indenter guide part 38 can be rotated about the center in which the longitudinal axes of the crimping indenters 30 intersect.

Both the activating part 31 and the indenter guide part 38 are thus rotatable relative to the frame parts 33, 34 about the same rotational axis mentioned and independently of one another.

Preferably, the possible angle of rotation of the indenter guide part 38 is less than that of the activating part 31.

Rotation of the indenter guide part 38 is achieved in detail by a sliding part 40 that is fixedly connected to the frame guide part 32, namely in the exemplary embodiment by a connecting pin 41. Via a setting wheel 42 which is stationary with regard to a movement direction of the sliding part 40 and which, for example, via an external thread formed at the associated end of the sliding part 40, can act with an internal thread on said sliding part, the sliding part 40 can be moved to a lesser extent. This movement is transformed via the coupling via the frame guide part 32 into a corresponding circular movement of the indenter guide part 38.

Furthermore, FIG. 9 also shows the fastening means between the frame parts 33, 34.

As illustrated in FIG. 11, the indenter guide part 38 as a whole can be adjusted by an angle α which is preferably set between 5° and 15°.

FIG. 14 illustrates in a partial cut-open view a further embodiment of the tool according to FIGS. 1 to 4.

In the embodiment of FIG. 14, it is important in first instance that a rechargeable battery 43 is also disposed in the upper handle region 2. Said battery is disposed facing away from the jaw toward the rear of the pivot joint 8. Furthermore, it is important, even independently of the arrangement of the battery 43, that the handle region 2 is formed with a freely projecting end. At the end of the handle region 2, there is no vertical connection to the lower frame part.

An actuator switch which, as illustrated, is preferably configured as a push switch 44, is provided on the jaw side with respect to the pivot joint 8 and more preferably on the upper side on the handle region 2.

The stationary tool leg 6 is connected to the leg 28 of the frame or, as an alternative, is formed as one piece therewith. The leg 28 is one of the legs that remains here as compared with the embodiment of the FIGS. 1 to 4. The leg 27 is not implemented in this embodiment. The leg 6 is only partially implemented, up to the pivot joint 8. The leg 26 can be implemented according to the embodiment of the FIGS. 1 to 3. However, said leg is provided specifically and preferably only in the form of the mount portion 45. The leg 28 extends into the mount portion 45 which runs substantially transverse to a longitudinal extent of the longitudinal axis A. The mount portion 45 further extends preferably in the front end region of the electric motor, i.e., in the end region facing toward the jaw, or in the end region of a drive flanged onto the electric motor. However, this means it extends upstream of the worm 17. The mount portion 45 holds the drive and/or the motor 9.

With regard to a projection of the electric motor 9 in the horizontal direction, see projection boundary lines l₁ and l₂, the activating part 15 or, where applicable, specifically the worm wheel 15, is disposed such that it protrudes into this projection region (from above). This relates to all embodiments described herein. However, it does not pass through this projection region.

Furthermore, with regard to the embodiment of FIG. 14, reference is made to the explanations with regard to the embodiment of FIGS. 1 to 4. Further details described there are also implemented or can also be implemented in this embodiment.

The embodiment of FIG. 15 relates to a configuration of the tool with crimping indenters according to the embodiment of FIGS. 5 to 13.

The rechargeable battery 43 is disposed here axially behind the motor 9. In addition to or independently of this, it is of importance that the handle region is formed such that the electric motor 9 and/or the battery 43 are enclosed. The device as a whole is rod-shaped and has a protrusion at the jaw.

The protrusion, which also results overall in an L-shaped contour of the device, is formed in detail by frame parts 33; double frame parts, thus 33, 34, can also be provided here. However, these frame parts are formed shorter compared to the frame parts of the embodiment of FIGS. 5 to 13. In particular, they do not form an upper handle region since, as explained, it is provided here that the handle region surrounds the electric motor 9 and/or the battery 43.

Moreover, as is also the case in the embodiment of FIG. 14, a fully enclosing housing 46 is provided. In the embodiments of FIGS. 14 and 15, the motor 9 can be additionally or solely held by the housing 46.

Apart from that, as can be seen, a configuration in accordance with the device described with regard to FIGS. 5 to 13 is provided so that in this respect the full content of these explanations is also hereby included by reference.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optional subordinated formulation characterize independent inventive refinement of the prior art, in particular to undertake divisional applications based on these claims.

### REFERENCE LIST

1 Tool
2 Handle region
3 Housing region
4 Grip-through opening
5 Jaw
6 Tool leg
7 Tool leg 7a Plate part 7b Plate part
8 Pivot joint
9 Motor
10 Tip
11 Toggle lever drive
12 Toggle joint
13 Lever
14 Lever
15 Worm wheel
16 Motor shaft
17 Worm
18 End stop
19 Switch
20 Flank
21 Widened portion
22 Crimping insert
23 Crimping insert
24 Housing portion
25 Vertical portion
26 Leg
27 Front third leg
28 Fourth rear leg
29 Axle
30 Crimping indenter
31 Activating part
32 Frame guide part
33 Frame part
34 Frame part
35 Adjustment guide
36 Setting part
37 Opening
38 Indenter guide part
39 Fixing pin
40 Sliding part
41 Connecting pin
42 Setting wheel
43 Rechargeable battery
44 Slide switch
45 Mount portion
46 Housing
A Longitudinal axis
L Length
l₁ Projection line
l₂ Projection line
G Total length
H Height

1-22. (canceled)

23. A tool (1), for example a crimping tool, comprising an activating part, a movable tool leg (7) and a stationary tool leg (6), the activating part (31), furthermore, being movable in a motorized manner for moving the movable tool leg (7) relative to the stationary tool leg (6), wherein a longitudinal axis (L) of an electric motor (9) provided for driving the activating part (31) extends below the activating part (31) when the motor is oriented horizontally, wherein a handle region (2) of the tool (1) extends above the electric motor (9) and independently thereof, wherein the activating part is arranged to be rotatable, and wherein for driving the activating part (31), the electric motor (9) acts via a worm (17) on a worm wheel (15), a longitudinal axis of the worm (17) being disposed to coincide with the longitudinal axis (L) of the electric motor (9).

24. A crimping tool comprising an activating part, wherein the activating part is movable in a motorized manner, wherein a longitudinal axis (L) of an electric motor (9) provided for driving the activating part (31) extends below the activating part (31) when the motor is oriented horizontally, wherein a handle region (2) of the tool (1) extends above the electric motor (9) and independently thereof, wherein the activating part is pivotable, and wherein for driving the activating part (31), the electric motor (9) acts via a worm (17) on a worm wheel (15), a longitudinal axis of the worm (17) being disposed to coincide with the longitudinal axis (L) of the electric motor (9), and wherein the activating part, which is formed as a toggle drive, is formed as one piece with the worm wheel (15) and a lever (14).

25. The tool according to claim 23, wherein a grip-through opening (4) is formed between the handle region (2) and the electric motor (9).

26. The tool according to claim 25, wherein the grip-through opening (4) is open on one side.

27. The tool according to claim 23, wherein the movable tool leg (7) is pivoted at a pivot joint (8) formed on the stationary tool leg (6) so as to be pivotable relative to the stationary tool leg (6).

28. The tool according to claim 23, wherein the motor (9) is mounted on a part that is fixedly connected to the stationary tool leg (6).

29. The tool according to claim 27, wherein the motor (9) acts on the movable tool leg (7) on the jaw side of the pivot joint (8).

30. The tool according to claim 23, wherein the tool legs (6, 7) extend in a common handle portion.

31. The tool according to claim 27, wherein the pivot joint (8) is located in the handle region (2).

32. The tool according to claim 23, wherein activating is carried out by means of a toggle lever drive (11).

33. The tool according to claim 32, wherein in a side view of the tool (1), the toggle lever drive (11) is disposed between the motor shaft (16) and the movable tool leg (7)

34. The tool according to claim 23, wherein the motor (9) acts on a gear wheel (15) that forms, at the same time, a lever of the toggle mechanism.

35. The tool according to claim 23, wherein a tool cheek piece, preferably the whole movable tool leg (7), is composed of plate parts (7a, 7b), and the force transmission of the motor (9) to the movable tool leg (7) takes place on a web connecting the plates.

36. The tool according to claim 27, wherein with regard to a horizontal orientation of the tool legs (6, 7), the motor (9) is disposed below the tool legs (6, 7) and extends at least partially on the jaw side relative to the pivot joint (8).

37. The tool according to claim 23, wherein a grip-through opening (4) is formed between the motor (9) and the tool legs (6, 7) for holding the tool by hand.

38. The tool according claim 23, wherein the activating part (15) is disposed to protrude into a horizontal projection of the motor (9) (projection lines (l₁, l₂)).
